(19) United States
(12) Patent Application Publication
(10) Pub. No.: US 2018/0363729 A1
(43) Pub. Date: Dec. 20, 2018

(54) END FITTING AND RATCHET TURNBUCKLE

(71) Applicant: Marathon Petroleum Company LP, Findlay, OH (US)

(72) Inventors: Christopher S. Stephens, Lavalette, WV (US); Shawn McClaskey, Ironton, OH (US)

(73) Assignee: Marathon Petroleum Company LP, Findlay, OH (US)

(21) Appl. No.: 15/904,945

(22) Filed: Feb. 26, 2018

Related U.S. Application Data
(63) Continuation-in-part of application No. 14/640,375, filed on Mar. 6, 2015, now abandoned.

(51) Int. Cl. F16G 11/12; F16B 7/06; B63B 21/62; B63B 21/04

(52) U.S. Cl. CPC F16G 11/12; B63B 21/04; B63B 21/62; F16B 7/06

(57) ABSTRACT

A ratchet turnbuckle for expanding or contracting the distance between tethered workpieces. The ratchet turnbuckle includes an end fitting having a pair of stabilizer bars and a swivel unit.

### CROSS REFERENCE TO RELATED APPLICATION

The present patent application is a continuation in part of U.S. patent application Ser. No. 14/640,375 filed Mar. 6, 2015, currently pending, which claims the benefit of U.S. Provisional Patent Application 61/949,636 filed Mar. 7, 2014. All subject matter contained in both applications is expressly incorporated herein.

### FIELD OF THE INVENTION

This invention relates to a ratchet turnbuckle. More specifically, the ratchet turnbuckle is intended for use with cables to securely tie a plurality of barges together for transport via a tugboat.

### BACKGROUND OF THE INVENTION

A ratchet turnbuckle is comprised of a sleeve which is internally threaded in opposite directions at its opposed ends and equipped with a ratchet and a handle. Rods having opposing thread patterns are secured or threaded into the opposed internal threads of the sleeve such that when the sleeve is rotated in one direction, the two threaded rods move toward each other. When the sleeve is rotated in the opposed direction, the two threaded rods move away from each other. Ratchet turnbuckles have countless applications and are applied in many different industries, however, the present invention is directed towards marine applications, including but not limited to, securing multiple barges together. A ratchet turnbuckle is used in conjunction with a wire rope or cable to draw large barges together and hold them in place. A common problem associated with such ratchet turnbuckles finds that, as the ratchet is rotated, the cable has a tendency to twist, creating a dangerous force, commonly upwards of 5-7 tons, that can cause the turnbuckle to suddenly spin, putting the user at risk.

A metal rod referred to in the industry as a “toothpick” has often been used to stabilize the turnbuckle ratchet. However, these “toothpicks” are unstable and may work loose, thus allowing the turnbuckle to dangerously flip.

Thus, an object of this invention is to provide a ratchet turnbuckle that absorbs the twisting forces that occur when the ratchet is activated.

Yet another object of the invention is to eliminate twisting forces occurring on the cables attached to the ratchet turnbuckle as the turnbuckle is being activated.

### SUMMARY OF THE INVENTION

A ratchet turnbuckle has been designed to specifically prevent flipping or turning of the turnbuckle while the turnbuckle is being operated to draw two large objects, such as marine barges, tightly together in a tethered state using cables, wire, ropes or chains or the like. The ratchet turnbuckle of the present invention provides a sleeve having opposed internal thread patterns located at the opposed ends of the sleeve. Rods, having opposing thread patterns, are engaged with the opposing internal thread patterns at each end of the sleeve such that, upon rotation of the sleeve in one direction, the rods move linearly away from each other and, upon rotation of the sleeve in the opposed direction, the rods move linearly toward each other. End caps are fixed to the exposed distal ends of the rods. Each end cap includes stabilizer bars extending radially outward from the end cap. A swivel unit is attached to each end cap. Each swivel unit includes a latch means for engaging a cable, wire, or other tethering means. The swivel unit and stabilizer bars allow the wire rope or cable to stay stationary while the turnbuckle is rotated. As pressure is applied to the ratchet turnbuckle and the threaded rods are drawn inward the stabilizer bars and the swivel end fittings rest on a surface of the barge and prevent the forces that are applied to turning the ratchet turnbuckle from translating to the cable.

### IN THE DRAWINGS

FIG. 1 is a top view of a ratchet turnbuckle with the swivel end fittings of the present invention attached to distal ends of the threaded rods of the turnbuckle.

FIG. 2 is an end view of a swivel end fitting as used in FIG. 1.

### DETAILED DESCRIPTION OF THE INVENTION

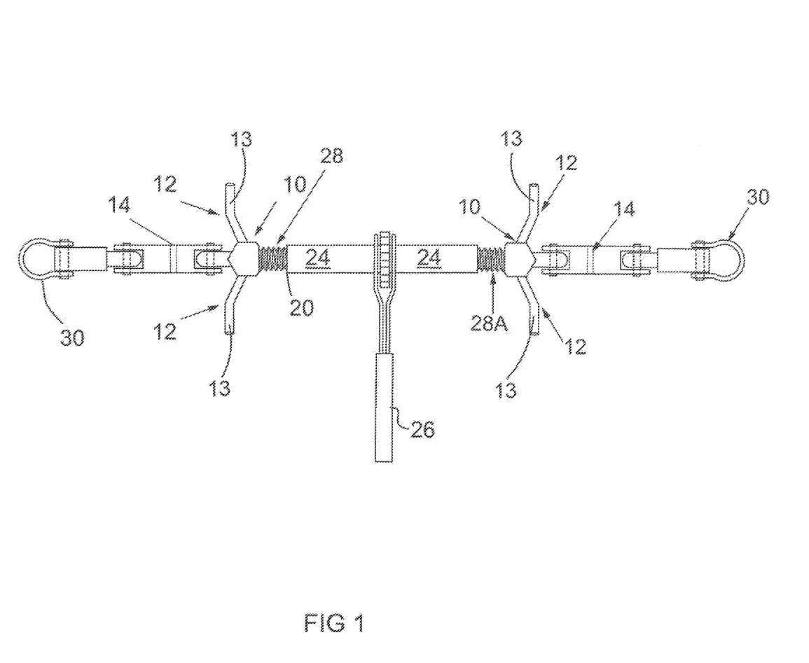

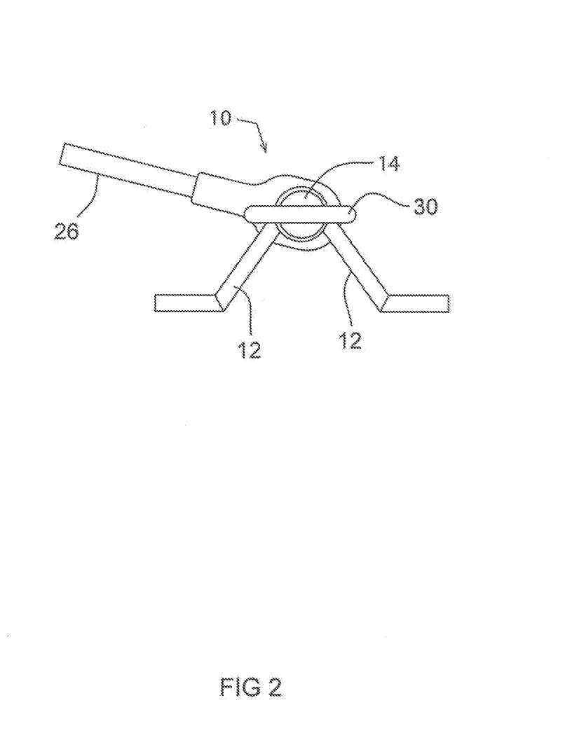

Referring now to FIGS. 1-2, the ratchet turnbuckle of this invention is shown. Ratchet turnbuckle 22 includes a cylindrical sleeve 24 having internal thread patterns disposed in one direction located on one end of the sleeve (not shown). The opposed end of the sleeve 24 includes internal thread patterns (not shown) disposed in an opposite direction to the thread pattern on the first end of sleeve 24. A first threaded rod 28 having a thread pattern disposed in one direction is threaded into the first end of the sleeve 24. A second threaded rod 28A having a pattern disposed in an opposed direction to the thread pattern of the first rod 28 is threaded into the opposed end of sleeve 24. The rotation of sleeve 24 by ratchet 26 will drive the rods 28, 28A toward or away from each other, thus shortening or expanding the distance between the tethered workpieces. End fittings 10 are attached to the exposed distal ends of rods 28, 28A. Each end fitting includes a pair of stabilizer bars 12 and a cable swivel unit 14. The stabilizer bars 12 have legs 13 extending radially outward which are configured to prevent the twisting force applied to a ratchet turnbuckle from translating to and twisting the attached cables.

Sometimes the sheer weight and size of the tethered workpieces, such as marine barges, will cause the ratchet turnbuckle to over torque and attempt to impart the rotational forces being imparted to the turnbuckle to translate to the cables, creating a dangerous condition. The legs 13 of the stabilizer bars 12 will engage a surface of the barge and the swivel end fittings 10 will absorb the twisting forces and prevent the translation of the rotational forces imparted on the ratchet turnbuckle 22 to the attached cables.

The above detailed description of the present invention is given for explanatory purposes. It will be apparent to those skilled in the art that numerous changes and modifications can be made without departing from the scope of the invention. Accordingly, the whole of the foregoing description is to be construed in an illustrative and not a limitative sense, the scope of the invention being defined solely by the appended claims.

We claim:

1. A ratchet turnbuckle for use in engaging with tethering means used to securely tie a plurality of barges together, comprising, in combination:
a sleeve having a first end internally threaded in one direction and a second end internally threaded in an opposed direction to the threading in the first end;
a ratchet and a handle engaged with the sleeve;
a first rod having thread patterns disposed in a first direction threaded into the first end of the sleeve, and a second rod having thread patterns disposed in a direction opposite to the thread patterns of the first rod threaded into the opposed end of the sleeve, the first and second rods having exposed distal ends outside of the sleeve member;
end caps fixed to the exposed distal ends of the rods, each end cap including stabilizer bars extending radially outward from the end cap for engaging with a surface of the barge;
swivel units engaged with each end cap, each swivel unit including latch means for engaging the tethering means; and
whereby rotational forces applied to the sleeve member by the ratchet and handle are absorbed by the stabilizer bars and swivel units, thereby preventing such rotational forces from being imparted to the tethering means.

2. The ratchet turnbuckle of claim 1 wherein the stabilizer bars include legs extending radially outward for engagement with a surface of the barge, the legs being configured to prevent rotational forces applied to the ratchet turnbuckle from translating to and twisting the attached tethering means.
